(19) United States
(12) Patent Application Publication
(10) Pub. No.: US 2021/0403328 A1
(43) Pub. Date: Dec. 30, 2021

(54) GRAPHITE PRODUCTION METHOD AND PRODUCTION DEVICE

(71) Applicant: KANEKA CORPORATION, Osaka (JP)

(72) Inventors: Takahiro Kotetsu, Osaka (JP); Naoto Iitsuka, Hyogo (JP); Toshihiko Kimura, Hyogo (JP)

(73) Assignee: KANEKA CORPORATION, Osaka (JP)

(21) Appl. No.: 17/472,025

(22) Filed: Sep. 10, 2021

Related U.S. Application Data
(63) Continuation of application No. PCT/JP2020/001737, filed on Jan. 20, 2020.

(30) Foreign Application Priority Data
Mar. 13, 2019 (JP) 2019-045806

(51) Int. Cl. C01B 32/205

(52) U.S. Cl. CPC C01B 32/205

(57) ABSTRACT

According to a graphite production method for producing graphite of higher quality, a maximum temperature inside a heating furnace of not less than 2900° C. causes an electrical discharge between a heater and a graphite container, and thus leads to a failure to efficiently convert electrical power into heat of the electrical heater. A graphite production method for producing graphite of higher quality is provided. Graphite having a higher heat diffusivity is obtained by carrying out a graphitization step such that a distance between a graphite container and the heater falls within a particular range of length, an atmosphere of a gas inside the heating furnace is set to contain a helium gas, and heating is carried out so that a maximum temperature inside the heating furnace is not less than 2900° C.

### TECHNICAL FIELD

One or more embodiments of the present invention relate to a graphite production method and a graphite production device.

### BACKGROUND

Graphite is produced by, for example, using a polymeric material as a raw material and subjecting the polymeric material to a carbonization step and a graphitization step. In the carbonization step, the polymeric material put in a graphite container is placed in a heating furnace, and is carbonized in the heating furnace at a temperature of approximately 1400° C. under reduced pressure, under vacuum, or under a nitrogen gas atmosphere, to obtain a carbide. In the graphitization step, the graphite container having the obtained carbide therein is converted into graphite in an argon gas under a temperature of up to 2500° C., to obtain graphite.

Patent Literature 1 discloses a heating furnace in which a helium gas or an argon gas is used in individual members of the heating furnace depending on the respective purposes of the members.

### PATENT LITERATURE

Patent Literature 1

Japanese Patent Application Publication Tokukai No. 2004-132587

It has been known that a higher maximum temperature in the graphitization step is preferable to obtain high-quality graphite, for example, graphite having a higher heat diffusivity and accordingly having high heat dissipation. However, the inventors of one or more embodiments of the present invention have found that increasing a maximum temperature in a large heating furnace capable of mass production, such as a heating furnace having a volumetric capacity of more than 2 m³, to a temperature of not less than 2900° C. to obtain high-quality graphite causes an electrical discharge between a heater and the graphite container, and thus could lead to a failure to efficiently convert an electrical power into heat of the electrical heater.

In other words, the inventors of one or more embodiments of the present invention have newly found, on their own, that the maximum temperature of not less than 2900° C. inside the heating furnace in a graphite production method for producing graphite of higher quality causes an electrical discharge between the heater and the graphite container, and could lead to a failure to efficiently convert electrical power into heat of the electrical heater.

### SUMMARY

One or more embodiments of the present invention provide a graphite production method and a graphite production device both of which prevent an electrical discharge between a heater and a graphite container in a heating furnace to produce graphite having a high heat diffusivity.

One or more embodiments of the present invention relate to a graphite production method below.

[1] A method for producing graphite, including a graphitization step of obtaining graphite by graphitizing, in a heating furnace including a gas supplying device and a heater, a carbide placed in a graphite container, the graphitization step being carried out such that (i) the graphite container is placed at a position such that a shortest distance from the heater to the position is more than 5 mm and less than 50 mm, (ii) an atmosphere of a gas inside the heating furnace is set such that, given that a total amount of the gas inside the heating furnace is 100 mol %, a proportion of a helium gas is more than 0 mol % and not more than 100 mol %, and (iii) the carbide is subjected to heat treatment by heating an inside of the heating furnace such that a maximum temperature is not less than 2900° C.

[2] The method as described in [1], wherein the graphite container is placed at a position such that the shortest distance from the heater to the position is not less than 20 mm and not more than 30 mm.

[3] The method as described in [1] or [2], wherein the atmosphere of the gas inside the heating furnace is set such that, given that the total amount of the gas inside the heating furnace is 100 mol %, a proportion of the helium gas is not less than 10 mol % and not more than 70 mol %.

Further, one or more embodiments of the present invention relate to a graphite production device below.

[4] A device for producing graphite, including a heating furnace for graphitizing a carbide placed in a graphite container, the heating furnace including: a housing; a heating furnace body; an electrical power feeding section made of graphite; and a heater made of graphite, the heating furnace body further including: a gas inlet pipe for letting an inert gas inside the heating furnace body; and a gas outlet pipe, the graphite container being placed at a position such that a shortest distance from the heater to the position is more than 5 mm and less than 50 mm.

[5] The device as described in [4], wherein the graphite container is placed at a position such that the shortest distance from the heater to the position is not less than 20 mm and not more than 30 mm.

[6] The device as described in [4] or [5], wherein the gas inlet pipe and the gas outlet pipe are configured to set an atmosphere of a gas inside the heating furnace such that, given that a total amount of the gas inside the heating furnace is 100 mol %, a proportion of a helium gas is not less than 10 mol % and not more than 70 mol %.

An aspect of one or more embodiments of the present invention makes it possible to prevent an electrical discharge between a heater and a graphite container in a heating furnace and thus increase a maximum temperature inside the heating furnace. This enables provision of a graphite production method and a graphite production device both of which make it possible to obtain graphite having a high heat diffusivity and accordingly having higher heat dissipation.

### BRIEF DESCRIPTION OF THE DRAWINGS

FIG. 1 is a front view schematically illustrating a configuration of a heating furnace.

FIG. 2 is a front view schematically illustrating the configuration of the heating furnace in which a distance between a graphite container and a heater is indicated.

### DETAILED DESCRIPTION OF THE EMBODIMENTS

The following description will discuss one or more embodiments of the present invention. One or more embodiments of the present invention are not limited to these embodiments, and can be altered in various ways by a person skilled in the art within the scope of this disclosure. Any embodiments based on a proper combination of technical means disclosed in different embodiments are also encompassed in the technical scope of one or more embodiments of the present invention.

A graphite production method in accordance with one or more embodiments of the present invention includes a graphitization step of obtaining graphite by graphitizing, in a heating furnace including a gas supplying device and a heater, a carbide placed in a graphite container. In the graphitization step, (i) the graphite container is placed at a position such that a shortest distance from the heater to the position is more than 5 mm and less than 50 mm, (ii) an atmosphere of a gas inside the heating furnace is set such that, given that a total amount of the gas inside the heating furnace is 100 mol %, a proportion of a helium gas is more than 0 mol % and not more than 100 mol %, and (iii) the carbide is subjected to heat treatment by heating an inside of the heating furnace such that a maximum temperature is not less than 2900° C.

<Polymeric Material>

Polymeric materials suitably used in the graphite production method of one or more embodiments of the present invention include, for example, polyimide, polyamide, polyoxadiazole, polybenzothiazole, polybenzobisthiazole, polybenzoxazole, polybenzobisoxasole, polyparaphenylene vinylene, polyphenylene benzimidazole, polyphenylene benzobisimidazole, and polythiazole. In particular, polyimide is preferable in terms of a heat diffusivity of the obtained graphite.

<Carbonization Step>

In the production of graphite, a carbonization step of carbonizing the polymeric material is carried out first, and then a graphitization step of converting into graphite (hereinafter, also referred to as graphitizing) the obtained carbide is carried out.

(Maximum Temperature)

The carbonization step is a step of carbonizing a polymeric material through heat treatment at approximately 1000° C. to obtain a carbide. A maximum temperature during the heat treatment may be, for example, 700° C. to 1800° C., 800° C. to 1500° C., 900° C. to 1200° C., or 1000° C.

(Temperature Increase Rate)

A temperature increase rate in the carbonization step may be, for example, 0.01° C./min to 20° C./min, 0.1° C./min to 10° C./min, 0.2° C./min to 5.0° C./min, or 0.5° C./min to 2.0° C./min

(Retention Time)

A retention time in the carbonization step, specifically a retention time of the maximum temperature, may be one minute to one hour, 5 minutes to 30 minutes, or 8 minutes to 15 minutes.

(Form of Polymeric Material)

In the carbonization step, a laminated body of rectangular polymeric material films stacked on top of each other may be carbonized (carbonization in the form of sheets); a polymeric material film in a roll form may be carbonized as it is in the roll form; or a polymeric material film in a roll form may be carbonized while being continuously unwound. In other words, the form of the polymeric material film in the carbonization step is not limited to a particular form.

<Graphitization Step>

In the graphitization step, the carbide obtained in the manner as described above is placed in a graphite container, and is subjected to heat treatment in a heating furnace at a predetermined temperature.

(Heating Furnace)

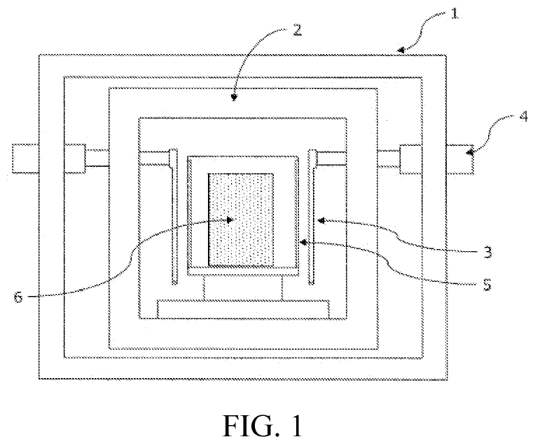

According to one or more embodiments of the present invention, it is possible to produce graphite by using, for example, a heating furnace illustrated in FIG. 1. FIG. 1 illustrates a heating furnace for producing graphite, wherein the heating furnace includes a housing 1, a heating furnace body 2 inside the housing 1, an electrical power feeding section 4 made of graphite, and a heater 3 made of graphite. According to the above-described graphite production method, the heating furnace body 2 is used in the graphitization step of graphitizing a carbide 6 placed in a graphite container 5 by burning (heat treatment) the carbide 6 at a high temperature of not less than 2900° C.

Optionally, the heating furnace body 2 may include a heater on the inside bottom thereof, and may further include a gas inlet pipe for letting an inert gas inside the heating furnace body 2, a gas outlet pipe, and the like. Note that the configuration and appearance of the heating furnace are not limited to those illustrated in FIG. 1.

(Distance Between Graphite Container and Heater)

In the graphitization step, in terms of preventing an electrical discharge, (i) the graphite container is placed at a position such that a shortest distance from the heater to the position may be more than 5 mm, not less than 7 mm, not less than 10 mm, or not less than 20 mm. Placing the graphite container at a position such that the shortest distance from the heater to the position is not more than 5 mm causes the passage of electricity through the heater and the graphite container, and thus could lead to a failure to increase the temperature of the graphite container. In addition, in terms of productivity, the graphite container is placed at a position such that the shortest distance from the heater to the position may be less than 50 mm, not more than 40 mm, or not more than 30 mm. Placing the graphite container at a position such that the shortest distance from the heater to the position is not less than 50 mm is less likely to cause an electrical discharge, but requires the graphite container to have a smaller volume. This could reduce productivity.

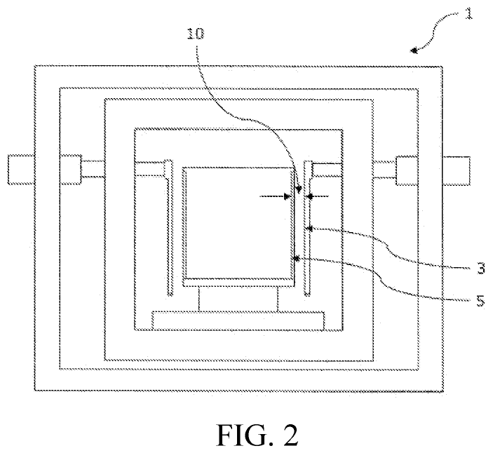

The distance between the graphite container and the heater is, for example, a distance 10 between the heater 3 and the graphite container 5, as illustrated in FIG. 2.

In the graphitization step in accordance with one or more embodiments of the present invention, the graphite container and the heater are not in contact with each other, and the distance between the graphite container and the heater, i.e., a distance which is the shortest (also referred to as the shortest distance from the heater) in the space between the outer wall of the graphite container and the heater, is more than 5 mm and less than 50 mm. The heater as used in one or more embodiments of the present invention is not limited to a heat generator alone. In a case where a member for covering the heat generator is provided, the heater refers to an overall configuration that includes both the heat generator and the covering member for covering the heat generator. Further, as used in one or more embodiments of the present invention, a non-contact state refers to a state where the container and the heating surface of the heater are separated from each other by a space (a gas layer or a vacuum space) (note that even if the container and the heater are partially in contact with each other, such a contact state is deemed to be a non-contact state in one or more embodiments of the present invention provided that the advantageous effects of one or more embodiments of the present invention are achieved). The container and the heater being in the non-contact state enable a uniform heat generation inside the heater through energization, and enable heating by such a heater to be uniform without non-uniform heating inside the graphite container. This makes it possible to obtain, in the graphite container, excellent graphite of a consistent quality.

On the other hand, when electricity is applied to the heater in a state in which the heater is in contact with the container, the electricity passes also to the graphite container via the contact area. This results in non-uniform heat generation in the heater, and thus makes it impossible to achieve uniform heating of the graphite container. This is less likely to achieve sufficiently consistent conversion of the raw material film (carbide) into graphite. When the graphite container is close to the heater, an electrical discharge occurs between the graphite container and the heater. This causes the graphite container and the heater to be worn out, and further makes it difficult to increase the temperature. For this reason, the graphite container is separated from the heater by more than 5 mm to prevent an electrical discharge and thus prevent the graphite container and the heater from being worn out. However, with the above-described distance, it is possible to increase the maximum temperature inside the heating furnace to less than 2900° C., but it is not possible to increase the maximum temperature to not less than 3000° C. since electrical discharges occur more strongly in the case of the increase to not less than 3000° C. Therefore, although a typical heating is carried out under an argon gas atmosphere, the heating in accordance with one or more embodiments of the present invention is carried out under an atmosphere in which, given that a total amount of a gas inside the heating furnace is 100 mol %, not less than 10 mol % of a helium gas is mixed with the argon gas. This makes it possible to increase the temperature to a high temperature region of not less than 3000° C. without generating any electrical discharge.

(Maximum Temperature inside Heating Furnace) In the graphitization step, a carbide is subjected to heat treatment by heating the inside of the heating furnace such that a maximum temperature is not less than 2900° C., may be not less than 3000° C., or not less than 3100° C.

(Graphitization Step/Temperature Increase Rate)

A temperature increase rate in the graphitization step may be, for example, 0.01° C./min to 20° C./min, 0.1° C./min to 10° C./min, or 0.5° C./min to 5.0° C./min.

(Retention Time)

A retention time of the maximum temperature in the graphitization step may be one minute to one hour, 5 minutes to 30 minutes, or 8 minutes to 15 minutes.

(Form of Carbide)

In the graphitization step, a laminated body of rectangular carbonaceous films stacked on top of each other may be graphitized; a carbonaceous film in a roll form may be graphitized as it is in the roll form; or a carbonaceous film in a roll form may be graphitized while being continuously unwound. In other words, the form of the carbonaceous film in the graphitization step is not limited to a particular form.

(Gas Pressure)

A gas pressure inside the heating furnace in the graphitization step may be higher than a gas pressure outside the heating furnace by 0.1 kPa to 200 kPa, by 2 kPa to 100 kPa, or by 5 kPa to 50 kPa. The gas pressure being higher than the gas pressure outside the heating furnace enables members inside the heating furnace, such as the heater, to be less likely to deteriorate.

(Gas Inside Graphite Container in Graphitization Step)

In the graphitization step, in terms of preventing an electrical discharge which is likely to occur in the high temperature region, (ii) an atmosphere of the gas inside the heating furnace is set such that, given that the total amount of the gas inside the heating furnace is 100 mol %, a proportion of a helium gas may be not less than 10 mol % and not more than 90 mol %, or not less than 20 mol % and not more than 70 mol %.

(Graphite Container)

A shape of the graphite container used in one or more embodiments of the present invention is not limited to a particular shape, and a shape such as a boxed shape and a cylindrical shape can be employed. Further, the graphite used as a material substance for the graphite container is broadly-defined graphite which covers various graphite materials mainly including graphite, provided that the materials can be heated to the above-described temperatures. Such graphite includes, for example, isotropic graphite and extruded graphite. The isotropic graphite, which is excellent not only in electrical conduction and thermal conduction but also in homogeneity, may be particularly preferable as a material substance for the graphite container. A thermal conductivity of the graphite used in one or more embodiments of the present invention as a material substance for the graphite container may be 5 W/(cm·K) to 500 W/(cm·K), 20 W/(cm·K) to 300 W/(cm·K), or 50 W/(cm·K) to 200 W/(cm·K).

(Heater and Electric Conductor in Non-Contact State)

In the heat treatment process for the graphitization in accordance with one or more embodiments of the present invention, it is preferable that the heater is not in contact with an electric conductor capable of flowing electrical current to the outside of the heating furnace. The electric conductor in one or more embodiments of the present invention refers to an electric conductor having an electrical resistivity of 10² Ωm to 10⁹ Ωm. When the electric conductor capable of flowing electrical current to the outside of the heating furnace comes into contact with the heater, a leakage of current occurs, and the leakage causes a malfunction in a device which controls electrical power for the heater, or damage to the members of the heater. This can cause a failure to increase the temperature of the heater. Furthermore, an electrical discharge (an electrical arc) occurs in the vicinity of the contact site between the heater and the electric conductor, and the occurrence of such an electrical discharge can break down the heater or the electric conductor in contact with the heater. In addition, it is preferable that electrical current should not substantially flow from the heater to the graphite container via the electric conductor. If current flows to the graphite container, a sample (a carbide) kept in the graphite container can suffer damage such as tearing and soiling.

### EXAMPLES

(Evaluation of Electrical Discharge State)

Whether an electrical discharge was occurring between the heater and the graphite container was evaluated on the basis of a change in an apparent resistance of the heater, which was obtained from voltage-current data of the heater denoted by a reference sign “3” in FIG. 1. As a temperature approaches the maximum temperature, both the current and the voltage increase. Therefore, a value obtained by dividing the voltage by the current, i.e., the apparent resistance of the heater, takes a predetermined value depending on the temperature. On the other hand, when an electrical discharge occurs, the current significantly increases and the voltage decreases in the high temperature region. In other words, when an electrical discharge occurs between the heater and the graphite container, the apparent resistance of the heater significantly decreases to such an extent that the physical properties of graphite cannot account for. Such a decrease in the apparent resistance of the heater occurs because argon in the atmosphere gas is ionized into argon ions under a high temperature condition, and electrical discharges accordingly occur across the space of the heating furnace and cause short-circuit current to flow. The decrease in the apparent resistance was, however, prevented by adding a helium gas at a proportion of at least 10 mol %, and it was evaluated that no electrical discharge occurred. Specifically, in a case where the apparent resistance of the heater gradually decreased as the temperature inside the heating furnace approached a high temperature, it was determined that an electrical discharge occurred (discharge occurred), and in a case where the apparent resistance of the heater did not decrease even at the high temperature, it was determined that no electrical discharge occurred (no discharge).

### Example 1

Two thousand sheet-type polyimide films each being 254 mm wide, 310 mm long, and 50 μm thick were stacked, and placed in the graphite container measuring 370 mm wide, 370 mm deep, and 500 mm high as illustrated FIG. 1. The graphite container having the sheet-type polyimide films therein was placed in the heating furnace, as illustrated in FIG. 1, such that the shortest distance from the heater to the graphite container was 20 mm. After the door of the heating furnace was closed, the inside of the heating furnace was brought under a nitrogen atmosphere. The temperature inside the heating furnace was increased to 1400° C. at a temperature increase rate of 10° C./min, and the sheet-type polyimide films were carbonized. Then, the whole nitrogen inside the heating furnace was replaced with a gas composed of 10 mol % of a helium gas and 90% of an argon gas. Subsequently, the temperature inside the heating furnace was increased at a temperature increase rate of 5° C./min. After reaching 3100° C., the temperature was kept for 15 minutes to graphitize the carbide, so that sheet-type graphite was obtained. In the graphitization step, no electrical discharge occurred, and the maximum temperature inside the heating furnace was 3100° C.

The sheet-type graphite thus obtained was 228 mm wide, 279 mm long, and 25 μm thick, and had a heat diffusivity of 10.4 cm²/s.

### Example 2

Sheet-type graphite was obtained as in Example 1, except that the atmosphere gas inside the heating furnace in the graphitization step was a gas composed of 50 mol % of a helium gas and 50% of an argon gas. In the graphitization step, no electrical discharge occurred, and the maximum temperature inside the heating furnace was 3100° C.

The sheet-type graphite thus obtained was 228 mm wide, 279 mm long, and 25 μm thick, and had a heat diffusivity of 10.4 cm²/s.

### Example 3

Sheet-type graphite was obtained as in Example 1, except that the atmosphere gas inside the heating furnace in the graphitization step was a gas composed of 70 mol % of a helium gas and 30% of an argon gas. In the graphitization step, no electrical discharge occurred, and the maximum temperature inside the heating furnace was 3100° C.

The sheet-type graphite thus obtained was 228 mm wide, 279 mm long, and 25 μm thick, and had a heat diffusivity of 10.4 cm²/s.

### Comparative Example 1

Sheet-type graphite was obtained as in Example 1, except that the atmosphere gas inside the heating furnace in the graphitization step was a gas composed of 100% of an argon gas. In the graphitization step, an electrical discharge occurred, and the maximum temperature inside the heating furnace was 2890° C.

The sheet-type graphite thus obtained was 228 mm wide, 279 mm long, and 25 μm thick, and had a heat diffusivity of 8.7 cm²/s.

### Comparative Example 2

The carbonization and graphitization steps were carried out as in Example 1, except that the shortest distance from the heater to the graphite container was 0 mm. Since the heater and the graphite container were in contact with each other, electricity passed to the graphite container. Accordingly, it was impossible to increase the temperature of the graphite container.

### Comparative Example 3

The carbonization and graphitization steps were carried out as in Example 2, except that the shortest distance from the heater to the graphite container was 5 mm. Discharge craters were found both in the heater and in the graphite container.

### Example 4

The carbonization and graphitization steps were carried out as in Example 2, except that the shortest distance from the heater to the graphite container was 10 mm. No discharge craters were found both in the heater and in the graphite container.

Table 1 provides conditions and evaluations for Examples and Comparative Examples.

TABLE 1

| | Graphitization Step | | | Evaluation | | |
|---|---|---|---|---|---|---|
| | Shortest | | | | | |
| | Distance from | | | | | Heat |
| | Heater to | | Ratio | Whether | | Diffusivity |
| | Graphite | | by | Electrical | Maximum | of |
| | Container | Atmosphere | mol. % | Discharge | Temperature | Graphite |
| | (mm) | Gas | (He:Ar) | Occurred | (° C.) | (cm²/s) |
| Example 1 | 20 | He/Ar | 10:90 | No | 3100 | 10.4 |
| | | Mixed Gas | | Discharge | | |
| Example 2 | 20 | He/Ar | 50:50 | No | 3100 | 10.4 |
| | | Mixed Gas | | Discharge | | |
| Example 3 | 20 | He/Ar | 70:30 | No | 3100 | 10.4 |
| | | Mixed Gas | | Discharge | | |
| Example 4 | 10 | He/Ar | 50:50 | No | 2950 | — |
| | | Mixed Gas | | Discharge | | |
| Comparative | 20 | Ar Gas | | Discharge | 2890 | 8.7 |
| Example 1 | | | | Occurred | | |
| Comparative | 0 | He/Ar | 50:50 | Electricity | Unmeasurable | — |
| Example 2 | | Mixed Gas | | Passed to | | |
| | | | | Graphite | | |
| | | | | Container | | |
| Comparative | 5 | He/Ar | 50:50 | Discharge | Not | — |
| Example 3 | | Mixed Gas | | Occurred | Measured | |

The graphite production method and the graphite production device in accordance with one or more embodiments of the present invention enable production of graphite of higher quality.

### REFERENCE SIGNS LIST

1: housing
2: heating furnace body
3: heater
4: electrical power feeding section
5: graphite container
6: carbide
10: distance between the heater and the graphite container

Although the disclosure has been described with respect to only a limited number of embodiments, those skilled in the art, having benefit of this disclosure, will appreciate that various other embodiments may be devised without departing from the scope of the disclosure. Accordingly, the scope of the invention should be limited only by the attached claims.

1. A method for producing graphite, comprising:
a graphitization step of obtaining graphite by graphitizing, in a heating furnace including a gas supplying device and a heater, a carbide placed in a graphite container, the graphitization step being carried out such that
(i) the graphite container is placed at a position such that a shortest distance from the heater to the position is more than 5 mm and less than 50 mm,
(ii) an atmosphere of a gas inside the heating furnace is set such that, given that a total amount of the gas inside the heating furnace is 100 mol %, a proportion of a helium gas is more than 0 mol % and not more than 100 mol %, and
(iii) the carbide is subjected to heat treatment by heating an inside of the heating furnace such that a maximum temperature is not less than 2900° C.

2. The method according to claim 1, wherein the graphite container is placed at a position such that the shortest distance from the heater to the position is not less than 20 mm and not more than 30 mm.

3. The method according to claim 1, wherein the atmosphere of the gas inside the heating furnace is set such that, given that the total amount of the gas inside the heating furnace is 100 mol %, the proportion of the helium gas is not less than 10 mol % and not more than 70 mol %.

4. The method according to claim 2, wherein the atmosphere of the gas inside the heating furnace is set such that, given that the total amount of the gas inside the heating furnace is 100 mol %, the proportion of the helium gas is not less than 10 mol % and not more than 70 mol %.

5. A device for producing graphite, comprising
a heating furnace for graphitizing a carbide placed in a graphite container,
the heating furnace including: a housing; a heating furnace body; an electrical power feeding section made of graphite; and a heater made of graphite,
the heating furnace body further including: a gas inlet pipe for letting an inert gas inside the heating furnace body; and a gas outlet pipe, and
the graphite container being placed at a position such that a shortest distance from the heater to the position is more than 5 mm and less than 50 mm.

6. The device according to claim 5, wherein the graphite container is placed at a position such that the shortest distance from the heater to the position is not less than 20 mm and not more than 30 mm.

7. The device according to claim 5, wherein the gas inlet pipe and the gas outlet pipe are configured to set an atmosphere of a gas inside the heating furnace such that, given that a total amount of the gas inside the heating furnace is 100 mol %, a proportion of a helium gas is not less than 10 mol % and not more than 70 mol %.

8. The device according to claim 6, wherein the gas inlet pipe and the gas outlet pipe are configured to set an atmosphere of a gas inside the heating furnace such that, given that a total amount of the gas inside the heating furnace is 100 mol %, a proportion of a helium gas is not less than 10 mol % and not more than 70 mol %.
